(19) United States
(12) Patent Application Publication
(10) Pub. No.: US 2018/0352078 A1
(43) Pub. Date: Dec. 6, 2018

(54) SECURE CALL SYSTEM AND METHOD

(71) Applicant: BARO SERVICE CO., LTD., Geumcheon-gu Seoul (KR)

(72) Inventors: Jae Young JUNG, Gangbuk-gu Seoul (KR); Yong Woo JEONG, Songpa-gu Seoul (KR)

(73) Assignee: BARO SERVICE CO., LTD., Geumcheon-gu Seoul (KR)

(21) Appl. No.: 15/771,489

(22) PCT Filed: Oct. 28, 2016
(86) PCT No.: PCT/KR2016/012246

§ 371 Date: Apr. 27, 2018

(30) Foreign Application Priority Data
Oct. 30, 2015 (KR) 10-2015-0152098

(51) Int. Cl. H04M 3/42; H04W 4/16; H04W 12/02

(52) U.S. Cl. CPC H04M 3/42008; H04M 3/42042; H04M 3/42127; H04W 12/02; H04W 4/16

(57) ABSTRACT

An embodiment of the present invention provides a computer-implemented secure call service method of a secure call system comprising a caller's phone, a receiver's phone, a secure call service server, and a call processing server.

### TECHNICAL FIELD

The present invention relates to a secure call system and method and more particularly, to a secure call system and method capable of blocking a caller's telephone number from being displayed on a called party's telephone.

### RELATED ART

In the case of conventional mobile devices capable of making a call, a caller himself or herself needs to input *23# before inputting a called party's telephone number to block the transmission of a telephone number associated with the caller's telephone. In this way, callers themselves need to input *23# each time they make a call so as to block the callers' telephone numbers from being displayed on called parties' telephones.

### DETAILED DESCRIPTION OF THE INVENTION

### Technical Problems

According to one or more embodiments of the present invention, provided is a secure call system and method capable of automatically blocking a caller's phone number from being displayed on a called party's telephone even though the caller does not input anything to block the caller's telephone from being displayed on the called party's telephone.

### Technical Solutions

According to one or more embodiments of the present invention, provided is a computer-implemented secure call service method including: a step in which a caller's telephone displays a telephone call screen for calling, which includes a menu for selecting a called party and making a request for a call (talking on the phone with) to the selected called party; a step in which the caller's telephone transmits a request for a call to a secure call service server when receiving the request for a call to the called party from the caller on the telephone call screen; a step in which the secure call service server or a call process server assigns any one of line numbers available for a call to the caller's telephone; a step in which the secure call service server transmits the assigned line number to the caller's telephone; a step in which the caller's telephone makes a call at the assigned line number; a step in which the call process server receives the called party's telephone number from the secure call service server; and a step in which the call process server forwards the call, made by the caller's telephone at the assigned line number, to the called party's telephone number, and wherein the request for a call transmitted by the caller's telephone to the secure call service server includes the caller's identification information and the called party's identification information, the caller's identification information includes at least one of the caller's user ID, program ID and telephone number, and the called party's identification information includes at least one of the called party's user ID and telephone number.

According to one or more embodiments of the present invention, provided is a secure call system including a caller's telephone, a called party's telephone, a secure call service server and a call process server, in which the caller's telephone displays a telephone call screen for calling, which includes a menu for selecting a called party and making a request for a call to the selected called party, and then, transmits the request for a call to the secure call service server when receiving the request for a call to the called party from the caller on the telephone call screen, the call process server assigns any one of line numbers available for a call to the caller's telephone, or the secure call service server requests the call process server to assign a line number and then, receives the assigned line number from the call process server to transmit the assigned line number to the caller's telephone when the secure call service server receives the request for a call from the caller's telephone, the caller's telephone makes a call at the line number transmitted by the secure call service server, the call process server receives the called party's telephone number from the secure call service server, the call process server forwards a call, made by the caller's telephone at the assigned line number, to the called party's telephone when receiving the call that is made by the caller's telephone at the assigned line number, the request for a call transmitted by the caller's telephone to the secure call service server includes the caller's identification information and the called party's identification information, the caller's identification information includes at least one of the caller's user ID, program ID and telephone number, and the called party's identification information includes at least one of the called party's user ID and telephone number.

### Advantageous Effects

According to one or more embodiments of the present invention, provided is a secure call system and method capable of blocking a caller's number from being displayed on a called party's telephone by using a call process server and security service program capable of assigning to the caller's telephone a line number available for a call besides the caller's telephone number.

### BRIEF DESCRIPTION OF THE DRAWINGS

FIG. 1 is a view illustrating a secure call system according to an embodiment of the present invention.

FIGS. 2 to 9 are views illustrating various embodiments of the secure call system in FIG. 1.

### DESCRIPTION OF THE SYMBOLS

10: Mobile device (Caller's telephone) 11: Security service program
13: Calling program
20: Server (Secure call service server) 30: Call process server
40: Called party's telephone 50: Relay DB
60: Assignable line DB

### BEST MODE FOR CARRYING OUT THE INVENTION

Objects, other objects, features and advantages of the present invention will be easily understood on the basis of the description of the preferred embodiments that will be provided hereunder in relation to the attached drawings. The invention, however, may be embodied in various different forms and should not be construed as being limited only to the illustrated embodiments. Rather, these embodiments are provided as examples so that this disclosure will be thorough and complete and that the technical ideas of the present invention will be fully conveyed to those skilled in the art.

In this specification, it is to be understood that an element described as on another element means an element directly is formed on another element, or a third element may intervene between one element and another element. Meanwhile, terms such as “part”, “device”, “module” etc. set forth in this specification denote units in which at least one function or operation is carried out and may be embodied through hardware or software or a combination of hardware and software.

Throughout the specification, the wording of “transmit”, “communicate”, “send”, “receive”, “provide”, or “deliver” signals, data or information and “the like with similar meanings thereof” means that one element (“element A”) delivers signals, data or information directly to another element (“element B”) and also means that one element delivers signals, data or information to another element through one or more third elements (“element C”).

In this specification, it is to be understood that elements “relevant to each other in operation” are connected in a wired and/or wireless manner so as to send and/or receive data between the elements. Meanwhile, throughout the specification, even though the wording that one element (“element A”) and another element (“element B”) are relevant to each other in operation is not explicitly stated, it should be understood that element A and element B are “relevant to each other in operation” when element A performs functions thereof (element A) by receiving signals, data or information output by element B, or element B performs functions thereof (element B) by receiving signals, data or information output by element A.

In this specification, for instance, communication networks may consist of Wi-Fi. the Internet, a local area network (LAN), a wireless local area network (wireless LAN), a wide area network (WAN), a telephone network, a personal area network (PAN), 3G, 4G, Long-Term Evolution (LET), a voice network or a combination of two or more thereof.

Hereunder, the invention will be described in detail by referring to the attached drawings. In describing the particular embodiments that will be provided hereunder, various particulars are provided to describe the invention in detail and to enhance understanding of the invention. However, it will become apparent to readers who have enough knowledge to understand the art to which the invention pertains that the invention may be used without the particulars. In some cases, in describing the invention, detailed descriptions of the things that are well-known and are not closely related to the invention will be omitted if they are deemed to make the gist of the present invention unnecessarily vague.

In the following embodiments, like reference numerals refer to like elements for convenience's sake.

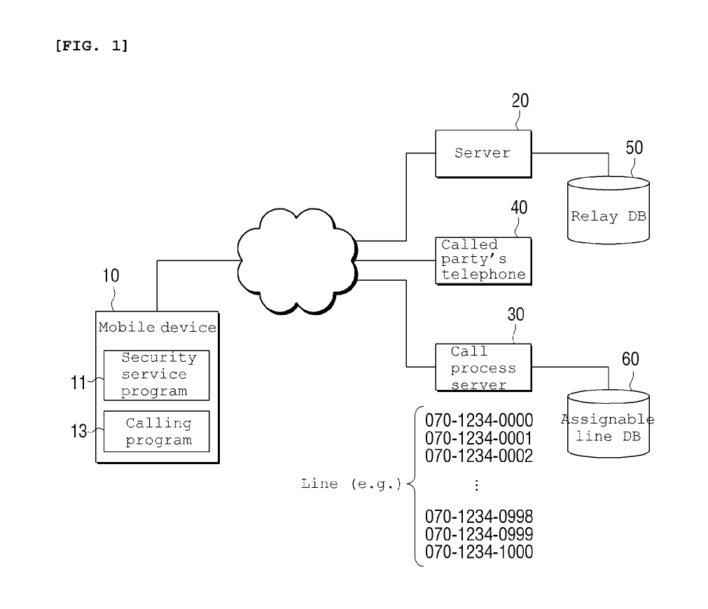

FIG. 1 is a view illustrating a secure call system according to an embodiment of the present invention.

With reference to FIG. 1, a computer-implemented secure call system may include a mobile device 10, a server 20, a call process server 30 and a called party's telephone 40. These elements may communicate with each other through a communication network.

The call process server 30 manages (stores, adds, deletes, corrects) an assignable line DB 60 containing a list of assignable lines so as to assign a line number to a caller's telephone 10.

With reference to FIG. 1, the caller's mobile device 10 (hereinafter referred to as “caller's telephone 10”) includes computer processors (invisible), memory (invisible) and operating systems (invisible), and the caller's telephone 10 and the called party's telephone 40, for instance, mean a device available to make a call such as a smartphone, a smart watch, a tablet, a PDA phone.

The caller's telephone 10 may display a telephone call screen for calling, which includes a menu for selecting a called party and making a request for a call to the selected called party.

In this embodiment, the caller's telephone 10 transmits the request for a call to the server 20 (hereinafter referred to as “secure call service server 20”) providing a secure call service when the caller selects a called party on the telephone call screen displayed by the caller's telephone 10. Herein, in the request for a call, a security service program ID or the called party's telephone number may be included.

When receiving the request for a call from the caller's telephone 10, the secure call service server 20 stores the telephone number of the caller's telephone 10 (hereinafter referred to as “caller's telephone number”) in a relay DB 50. The secure call service server 20 associates the called party's telephone number with the caller's telephone number and stores the called party's telephone number and the caller's telephone number in the relay DB 50.

The secure call service server 20 may obtain the caller's telephone number with reference to a member DB (invisible)—a database in which IDs and telephones numbers of members who installed a security service program 11 are associated and stored. The member DB (invisible) may be managed by a web server (invisible) providing the security service program 11.

When the caller's telephone 10 makes a request for a call to the secure call service server 20, the secure call service server 20 assigns and transmits a line number available for a call to the caller's telephone 10. Herein, the operation of assigning a line number available for a call may be performed by the call process server 30, and detailed descriptions of this will be provided hereunder. The caller's telephone 10 makes a call at the transmitted line number.

The caller's telephone 10 includes computer processors (invisible), memory (invisible) and operating systems (invisible) and includes a security service program 11 so as to receive a line number through the secure call service server 20 and Internet communication.

The caller's telephone 10 may exchange data with the secure call service server 20 connected to the Internet network and has software and hardware (invisible) available for voice calls.

The caller's telephone 10 denotes a mobile phone functioning as a personal computer (PC) and performing advanced functions, the smart watch denotes a wrist watch having an embedded system and performing functions that are more advanced than those of an ordinary watch, the tablet denotes a mobile PC having a touchscreen as a main input device, and the PDA phone denotes a personal digital assistant (PDA) provided with a mobile communication module.

The security service program 11 installed on the caller's telephone 10 is used to perform at least some of the functions necessary to provide a secure call service according to the present invention, and if there is a line number transmitted by the secure call service server 20, the security service program 11 pages a calling program 13 provided to the caller's telephone 10 to let the calling program make a call.

When paging a calling program 13, the security service program 11 provides to the calling program 13 the line number transmitted by the secure call service server 20. Afterwards, the calling program 13 makes a call at the line number provided by the security service program 11.

The call process server 30, for instance, may be an exchange device such as an Internet protocol private branch exchange (IP PBX, invisible) and may manage a plurality of telephone numbers.

The line number transmitted by the secure call service server 20 to the caller's telephone 10 may be any one of telephone numbers managed by the call process server 30.

When receiving the call from the caller's telephone 10, the call process server 30 transmits the caller's telephone number (i.e. the telephone number of the caller's telephone 10) to the secure call service server 20.

The secure call service server 20 may authorize the request (may determine to authorize the request), if the caller's telephone number transmitted by the call process server 30 is the same as the telephone number of the call requester stored in the relay DB 50 as a result of comparison between the caller's telephone number transmitted by the call process server 30 and the telephone number of the call requester stored in the relay DB 50. Further, the secure call service server 20 may authorize the request for a call only when the secure call service server 20 receives the caller's telephone number transmitted by the call process server 30 within a preset time from the “time of receiving the request for a call” stored in the relay DB 50.

When the secure call service server 20 receives the caller's telephone number transmitted by the call process server 30 after a preset time from the “time of receiving the request for a call”, the secure call service server 20 does not authorize the request for a call (determines not to authorize the request for a call), regardless of the result of comparison between the caller's telephone number transmitted by the call process server 30 and the telephone number of the call requester stored in the relay DB 50.

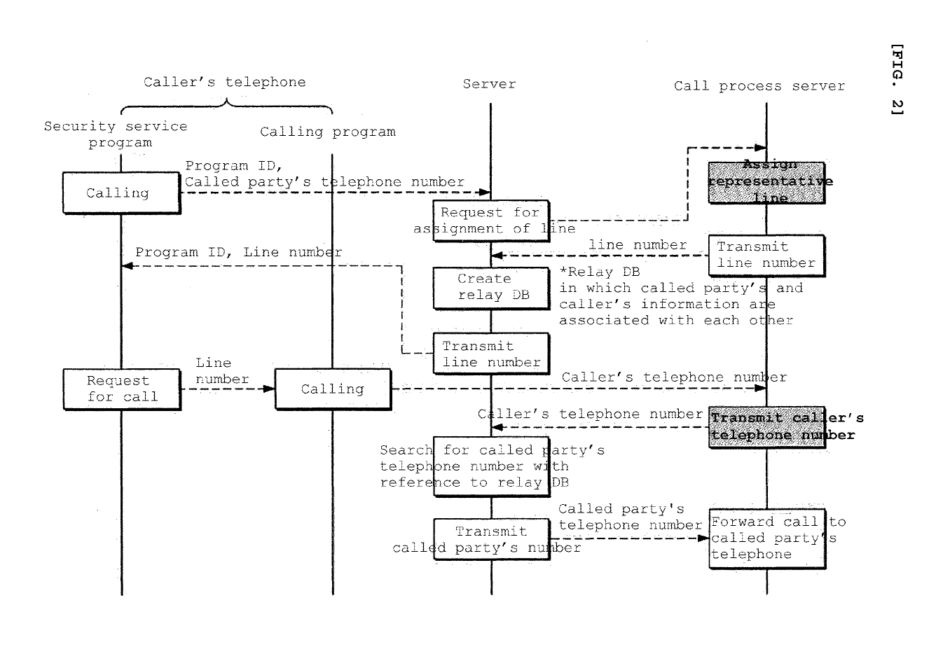

Hereunder, by respectively referring to FIGS. 2 to 9, more detailed embodiments of the secure call system in FIG. 1 will be described.

FIG. 2 is a view illustrating a secure call system according to an embodiment of the present invention, and the secure call system in FIG. 1 may be embodied to operate as the secure call system in FIG. 2.

With reference to FIGS. 1 and 2, a caller's telephone 10 according to an embodiment of the present invention displays a telephone call screen for calling, which includes a menu for selecting a called party and making a request for a call to the selected called party. More particularly, when a security service program 11 installed on the caller's telephone 10 provides the telephone call screen for calling to the caller's telephone 10, the caller's telephone 10 may display the telephone call screen provided by the security service program 11.

When receiving a request made by the caller for a call to a called party on the telephone call screen, the caller's telephone 10 transmits the request for a call to a secure call service server 20.

According to an embodiment, in the request for a call transmitted by the caller's telephone 10 to the secure call service server 20, the caller's identification information and the called party's identification information may be included.

For instance, the caller's identification information may include at least one of the caller's user ID, program ID and telephone number.

For instance, the called party's identification information may include at least one of the called party's user ID and telephone number.

Herein, the caller's user ID (or the called party's user ID) generally means the one used to receive a “caller ID” service—i.e. a CID service and may be the name of a person who made a call (caller), or the person's telephone number as a unique identification number.

The program ID denotes an identifier consisting of a program name, a program abbreviation, a program code number which are used to specify the security service program 11.

In this embodiment, the caller's telephone number and the called party's telephone number may be stored in advance in the secure call service server 20 when the security service program 11 of the present invention is installed.

In this embodiment, the caller's telephone 10 may transmit the request for a call together with a security service program ID and the called party's telephone to the secure call service server 20. Herein, the secure call service server 20 may provide the called party's telephone number transmitted by the caller's telephone 10 to a call process server 30.

In this embodiment, the call process server 30 may include an assignable line DB 60 capable of assigning a line number to the caller's telephone 10. The assignable line DB 60 may be configured to include a plurality of lines. Herein, the plurality of lines may include a “representative line” and an “individual line”. Detailed descriptions of the “representative line” and “individual line” will be provided hereunder.

In this embodiment, when receiving the request for a call from the caller's telephone 10, the secure call service server 20 may request the call process server 30 to assign a line number and receive a line number of the caller's telephone 10 from the call process server 30.

In this embodiment, the line number assigned by the call process server 30 to the secure call service server 20 may be a representative line number representing the call process server 30.

The representative line number denotes a line number which is identically assigned regardless of the caller's phone number the caller's phone 10 has. For instance, the representative line number is pre-designated as the number of 070-1234-0000, as illustrated in FIG. 1, and the call process server 30 always assigns the pre-designated number of 070-1234-0000 to the secure call service server 20 when receiving a request made by the secure call process server 20 for assignment of a line number.

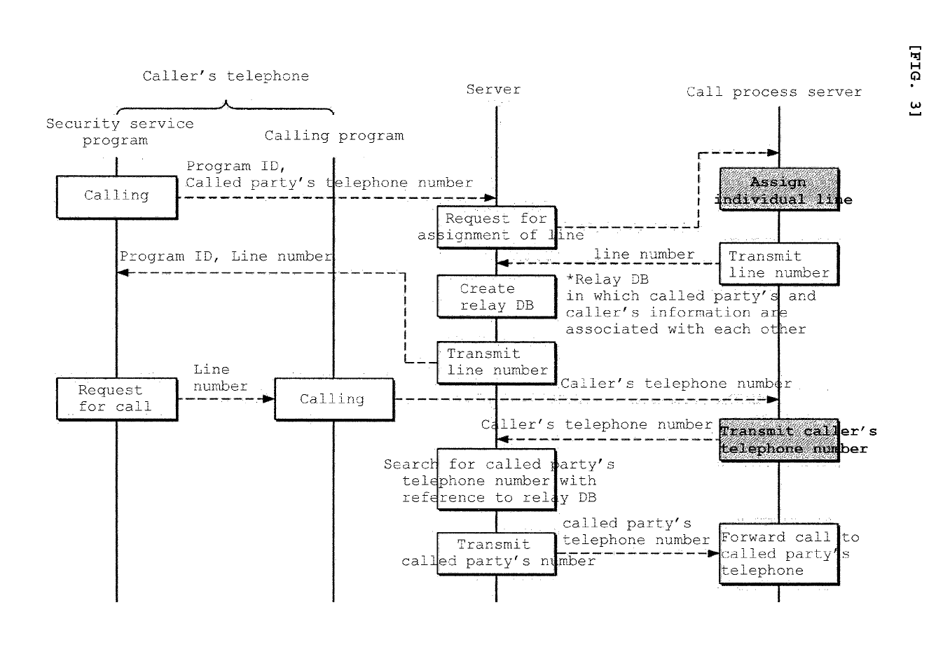

FIG. 3 is a view illustrating a secure call system according to an embodiment of the present invention, and the secure call system in FIG. 1 may be embodied to operate as the secure call system in FIG. 3.

With reference to FIG. 3, a line number which is assigned by a call process server 30 to a secure call service server 30 according to another embodiment of the present invention may be an individual line number which is individually assigned to the telephone number a caller's telephone 10 has.

For instance, the caller's telephone 10 may be configured to include a plurality of callers' telephones including a caller's telephone a “first caller” uses (hereinafter referred to as “first caller's telephone”) and a caller's telephone a “second caller” uses (hereinafter referred to as “second caller's telephone”), and the secure call service server 20 may receive a request for a call from the first caller's telephone or the second caller's telephone.

In this embodiment, when the secure call service server receives a request for a call from the first caller's telephone and requests the call process server 30 to assign a line number, the call process server 30 may assign to the first caller's telephone any one of the line numbers (e.g. 070-1234-0001), which are not currently used, in an assignable line DB 60 to transmit the line number to the secure call service server 20.

Meanwhile, when the secure call service server 20 receives a request for a call from the second caller's telephone and requests the call process server 30 to assign a line number, the call process server 30 may assign to the second caller's telephone one of the line numbers (e.g. 070-1234-0002), which are not currently used, in the assignable line DB 60 to transmit the line number to the secure call service server 20.

With reference to FIGS. 1 and 2, in this embodiment, the secure call service server 20 may transmit to the caller's telephone 10 a line number of the caller's telephone 10 assigned by the call process server 30.

In this embodiment, the secure call service server 20 may transmit to the caller's telephone 10 the line number of the caller's telephone 10 assigned by the call process server 30 together with a security service program ID.

In this embodiment, when the caller's telephone 10 receives the line number assigned to the caller's telephone 10 from the secure call service server 20, the security service program 11 transmits to a calling program 13 the assigned line number together with an instruction to call. The caller's telephone 10 executes the calling program 13 to call at the assigned line number.

In this embodiment, when receiving the call from the caller's telephone 10, the call process server 30 forwards the call, made by the caller's telephone 10 at the line number assigned to the caller's telephone 10, to a called party's telephone number. Herein, the called party's telephone number may be the one that the secure call service server 20 receives from the caller's telephone 10 together with a request for a call and afterwards, provides to the call process server 30.

With reference to FIG. 2, another embodiment of the present invention will be described hereunder.

With reference to FIG. 2, when receiving a request for a call from a caller's telephone 10, a secure call service server 20 according to another embodiment of the present invention may create and store a relay DB 50 including the time of receiving the request for a call.

The relay DB 50 may be configured to further include at least any one of a called party's telephone number, a caller's telephone number and a line number assigned to the caller's telephone. Herein, the relay DB 50 may associate the called party's telephone number with the caller's telephone number and store the called party's telephone number and the caller's telephone number.

In this embodiment, when receiving the request for a call from the caller's telephone 10, the secure call service server may request a call process server 30 to assign a line number and be assigned a line number of the caller's telephone 10 by the call process server 30.

In this embodiment, the secure call service server 20 may transmit to the caller's telephone 10 the line number of the caller's telephone 10 assigned by the call process server 30.

In this embodiment, when the caller's telephone 10 receives the line number assigned to the caller's telephone 10 from the secure call service server 20, the security service program 11 transmits to a calling program 13 the assigned line number together with an instruction to call. The caller's telephone 10 executes the calling program 13 to make a call at the assigned line number.

In this embodiment, when receiving the call made by the caller's telephone 10 at the line number assigned to the caller's telephone 10, the call process server 30 may transmit the caller's telephone number to the secure call service server 20. The secure call service server 20 may search for and obtain the called party's telephone number associated with the caller's telephone number transmitted by the call process server 30 with reference to the relay DB 50 and afterwards, transmit the called party's telephone number to the call process server 30.

In this embodiment, the call process server 30 may forward the call, made by the caller's telephone 10 at the line number assigned to the caller's telephone 10, to the called party's telephone number transmitted by the secure call service server 20.

In an embodiment, the secure call service server 20 may transmit the called party's telephone number associated with the caller's telephone number to the call process server 30 only when receiving the caller's telephone number from the call process server 30 within a preset time from the time associated with the caller's telephone number stored in the relay DB 50.

Being within a preset time from the time associated with the caller's telephone number stored in the relay DB 50 means being within a required period of time from the time when the secure call service server 20 receives the request for a call from the caller's telephone 10.

For instance, if the required period of time is 30 seconds, the secure call service server 20 transmits to the call process server 30 the called party's telephone number associated with the caller's telephone number only when receiving the caller's telephone number from the call process server 30 within 30 seconds from the time when the secure call service server 20 receives the request of a call from the caller's telephone 10. If the secure call service server 20 receives the caller's telephone number from the call process server 30 after 30 seconds from the time when the secure call service server 20 receives the request of a call from the caller's telephone 10, the secure call service server 20 may not transmit to the call process server 30 the called party's telephone number associated with the caller's telephone number. That is, a secure call is possible within a limited period of time, such that security in relation to a secure call may be improved.

In this embodiment, the preset time may be stored in a temporary DB 50 or in a separate storage device (memory (invisible) or hard disks provided to an authentication server 20).

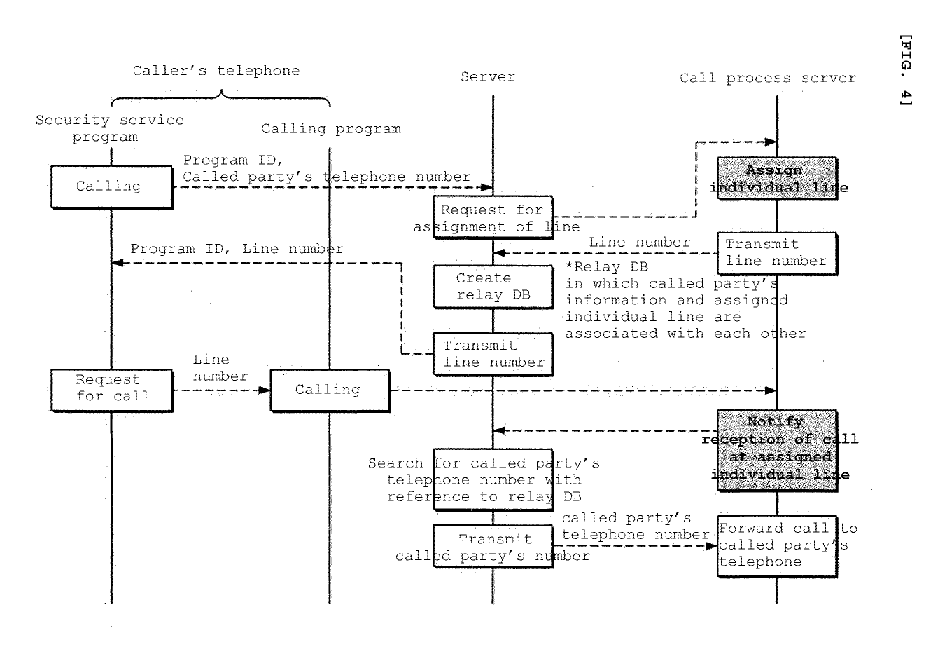

FIG. 4 is a view illustrating a secure call system according to an embodiment of the present invention, and the secure call system in FIG. 1 may be embodied to operate as the secure call system in FIG. 4.

With reference to FIG. 4, when receiving a request for a call from a caller's telephone 10, a secure call service server 20 according to another embodiment of the present invention may create and store a relay DB 50 including the time of receiving the request for a call.

In this embodiment, the relay DB 50 may be configured to further include at least any one of a called party's telephone number, a caller's telephone number and a line number assigned to the caller's telephone.

In comparison between the embodiment in FIG. 3 and the embodiment in FIG. 4, the relay DB 50 in the embodiment in FIG. associates the called party's telephone number with the caller's telephone number and stores the called party's telephone number and the caller's telephone number, but the relay DB 50 in the embodiment in FIG. 4 associates the called party's telephone number with the line number assigned to the caller's telephone and stores the called party's telephone number and the line number assigned to the caller's telephone.

With reference to FIG. 4, when receiving a call made by the caller's telephone 10 at the line number assigned to the caller's telephone 10, the call process server 30 notifies the secure call service server 20 that there is a call from the caller's telephone 10 at the assigned line number (hereinafter referred to as “call reception notification”).

In this embodiment, when notified from the call process server 30 that there is a call from the caller's telephone 10 at the assigned line number, the secure call service server 20 transmits to the call process server 30 the called party's telephone number associated with the line number assigned to the caller's telephone 10 with reference to the relay DB 50. The call process server 30 forwards the call, made by the caller's telephone 10 at the line number assigned to the caller's telephone 10, to the called party's telephone number transmitted by the secure call service server 20.

In the embodiment in FIG. 3, the call process server 30 may obtain the called party's telephone number only by transmitting the telephone number of the caller's telephone 10 (i.e. the caller's telephone number) as the caller's identification information to the secure call service server 20 even when the caller's telephone 10 makes a call at the assigned line number.

Meanwhile, the call process server 30 in the embodiment in FIG. 4 may obtain the called party's telephone number only by notifying the secure call service server 20 of reception of the call, not of the caller's telephone number.

According to an embodiment, the secure call service server 20 may transmit the called party's telephone number associated with the caller's telephone number to the call service server 30 only when receiving the call reception notification or the caller's telephone number from the call process server 30 within a preset time from the time associated with the line number assigned to the caller's telephone 10 stored in the relay DB 50.

Being within a preset time from the time associated with the line number assigned to the caller's telephone 10 stored in the relay DB 50 means being within a required period of time from the time when the secure call service server 20 receives the call reception notification from the call process server 30.

For instance, if the required period of time is 20 seconds, the secure call service server 20 transmits to the call process server 30 the called party's telephone number associated with the line number assigned to the caller's telephone 10 only when receiving the call reception notification or the caller's telephone number from the call process server 30 within 20 seconds from the time when the secure call service server 20 receives the call reception notification from the call process server 30. If the secure call service server 20 receives the call reception notification or the caller's telephone number from the call process server 30 after 20 seconds from the time when the secure call service server 20 receives the call reception notification from the call process server 30, the secure call service server 20 may not transmit to the call process server the called party's telephone number associated with the caller's telephone number. That is, a secure call is possible within a limited period of time, such that security in relation to a secure call may be further improved.

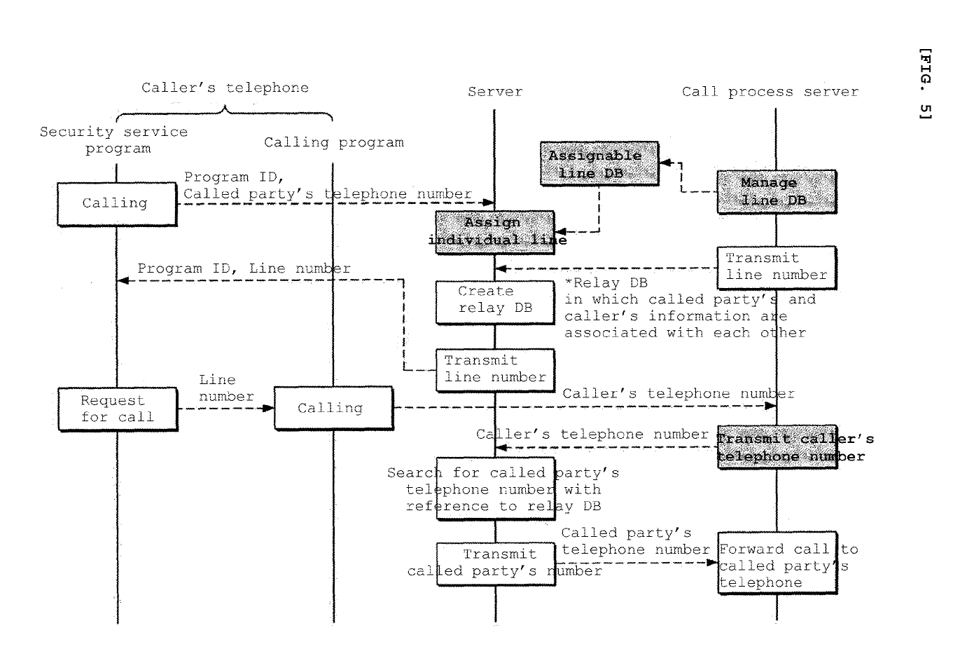

FIG. 5 is a view illustrating a secure call system according to an embodiment of the present invention, and the secure call system in FIG. 1 may be embodied to operate as the secure call system in FIG. 5.

With reference to FIG. 5, a caller's telephone 10 according to another embodiment of the present invention displays a telephone call screen for calling, which includes a menu for selecting a called party and making a request for a call to the selected called party, and transmits a request for a call to a secure call service server 20 when receiving the request for a call to a called party from a caller on the telephone call screen.

In this embodiment, when the secure call service server 20 receives the request for a call from the caller's telephone 10, a call process server 30 may select any one of line numbers available for a call and assign the line number to the caller's telephone 10.

A described above, the call process server 30 may include an assignable line DB 60 capable of assigning a line number to the caller's telephone 10 and manage the assignable line DB 60. Herein, managing the assignable line DB 60 includes deleting, correcting, adding and maintaining the assignment available line DB 60.

In comparison between the embodiment in FIG. 3 and the embodiment in FIG. 5, the call process server 30 in the embodiment in FIG. 3 assigns a line number to the caller's telephone 10 only when receiving a request for assignment of an assignable line number from the secure call service server 20.

Meanwhile, the call process server 30 in the embodiment in FIG. 5 may assign a line number, which are not currently used, in the assignable line DB 60 managed by the call process server 30 when the secure call service server 20 receives a request for a call from the caller's telephone 10 even though the call process server 30 does not receive the request for assignment of a line number from the secure call service server 20. Following operations are the same as those in FIG. 3 (see. descriptions of FIG. 3).

Though not illustrated, embodiments described with reference to FIG. 4 may be applied to other embodiments of the present invention referring to FIG. 5.

That is, in this embodiment, when notified from the call process server 30 that there is a call from the caller's telephone 10 at the assigned line number, the secure call service server 20 transmits to the call process server 30 the called party's telephone number associated with the line number assigned to the caller's telephone 10 with reference to a relay DB 50, and the call process server 30 may forward the call, made by the caller's telephone 10 at the line number assigned to the caller's telephone 10, to the called party's telephone number transmitted by the secure call service server 20.

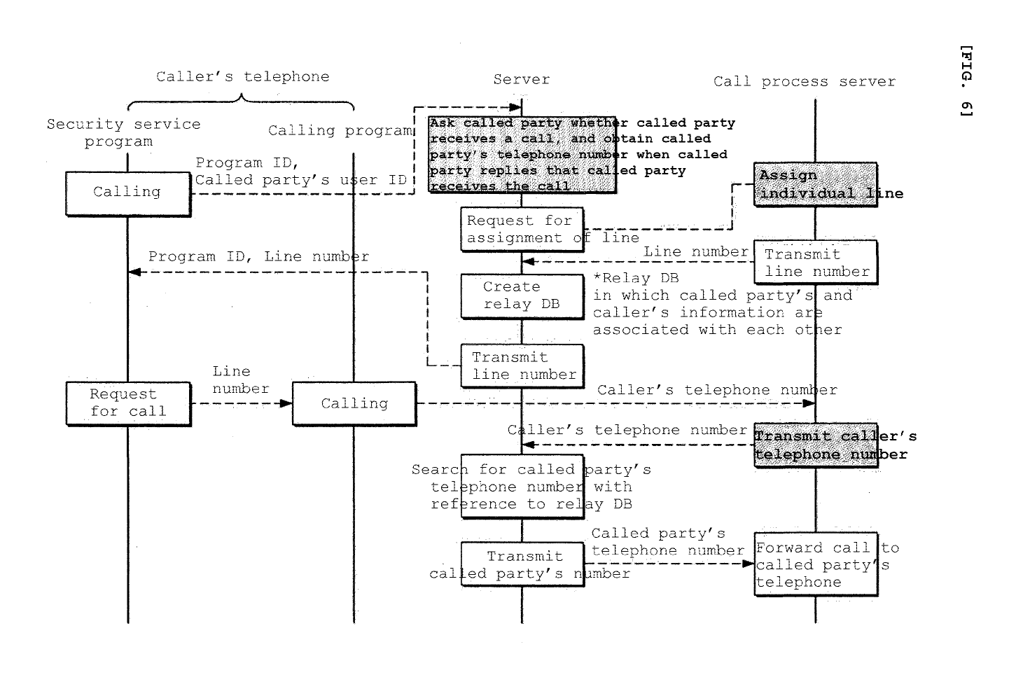

FIG. 6 is a view illustrating a secure call system according to an embodiment of the present invention, and the secure call system in FIG. 1 may be embodied to operate as the secure call system in FIG. 6.

With reference to FIG. 6, a caller's telephone 10 according to another embodiment of the present invention displays a telephone call screen for calling, which includes a menu for selecting a called party and making a request for a call to the selected called party, and transmits a request for a call to a secure call service server 20 when receiving the request for a call to a called party from a caller on the telephone call screen.

The request for a call transmitted by the caller's telephone 10 to the secure call service server 20 includes the caller's identification information and the called party's identification information, and in this embodiment, the called party's identification information may be the called party's user ID.

In this embodiment, the secure call service server 20 asks the called party's telephone 40 whether the called party's telephone 40 receives a call from the caller when the caller's telephone 10 makes the request for a call and may obtain the called party's telephone number from the called party's telephone 40 when receiving the reply from the called party's telephone 40 that the called party's telephone 40 receives the call (hereinafter referred to as “call permission reply”).

In comparison between the embodiment in FIG. 3 and the embodiment in FIG. 6, in the embodiment in FIG. 3, the called party's telephone number, as the called party's identification information, may be included in the request for a call transmitted by the caller's telephone 10 to the secure call service server 20, but in the embodiment in FIG. 6, the secure call service server 20 may obtain the called party's telephone number only when receiving the call permission reply from the called party. Following operations are the same as those in FIG. 3 (see. descriptions of FIG. 3).

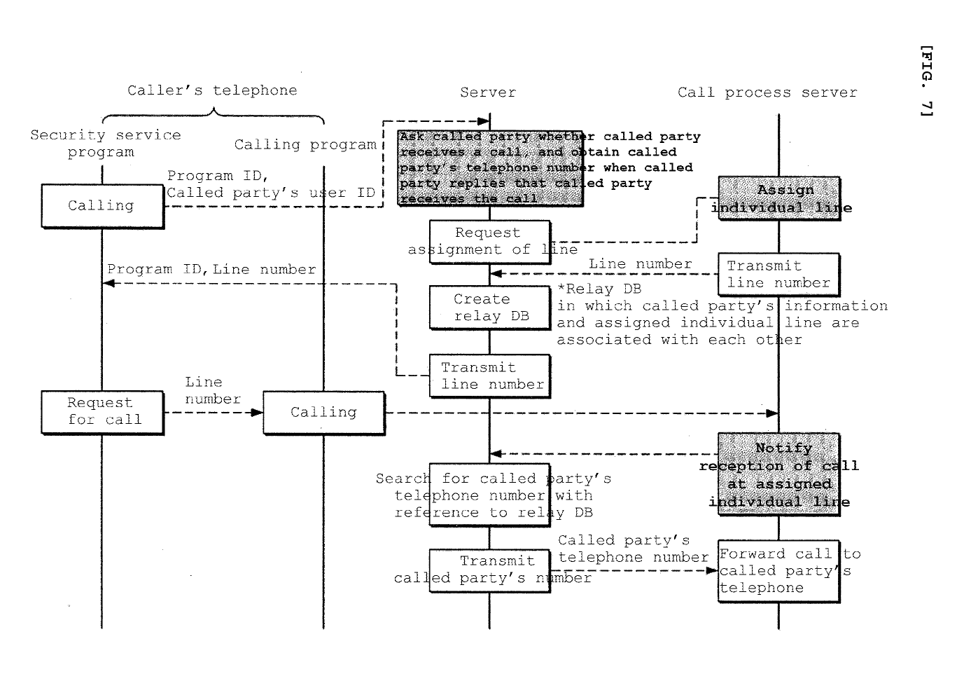

FIG. 7 is a view illustrating a secure call system according to an embodiment of the present invention, and the secure call system in FIG. 1 may be embodied to operate as the secure call system in FIG. 7.

With reference to FIG. 7, a caller's telephone 10 according to another embodiment of the present invention displays a telephone call screen for calling, which includes a menu for selecting a called party and making a request for a call to the selected called party, and transmits a request for a call to a secure call service server 20 when receiving the request for a call to a called party from a caller on the telephone call screen.

The request for a call transmitted by the caller's telephone 10 to the secure call service server 20 includes the caller's identification information and the called party's identification information, and in this embodiment, the called party's identification information may be the called party's user ID.

In this embodiment, the secure call service server 20 asks the called party's telephone 40 whether the called party's telephone 40 receives a call from the caller when the caller's telephone 10 makes the request for a call and may obtain the called party's telephone number from the called party's telephone 40 when receiving the reply from the called party's telephone 40 that the called party's telephone 40 receives the call (hereinafter referred to as “call permission reply”).

In comparison between the embodiment in FIG. 4 and the embodiment in FIG. 7, in the embodiment in FIG. 4, the called party's telephone number, as the called party's identification information, may be included in the request for a call transmitted by the caller's telephone 10 to the secure call service server 20, but in the embodiment in FIG. 7, the secure call process server 20 may obtain the called party's telephone number only when receiving the call permission reply from the called party. Following operations are the same as those in FIG. 4 (see. descriptions of FIG. 4).

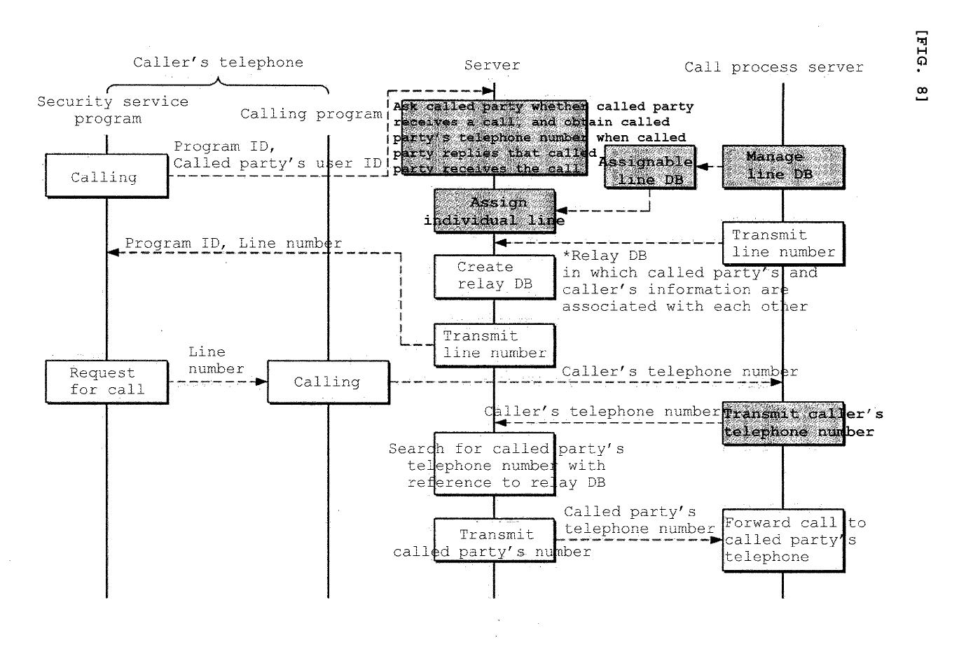

FIG. 8 is a view illustrating a secure call system according to an embodiment of the present invention, and the secure call system in FIG. 1 may be embodied to operate as the secure call system in FIG. 8.

With reference to FIG. 8, a caller's telephone 10 according to another embodiment of the present invention displays a telephone call screen for calling, which includes a menu for selecting a called party and making a request for a call to the selected called party, and transmits a request for a call to a secure call service server 20 when receiving the request for a call to a called party from a caller on the telephone call screen.

The request for a call transmitted by the caller's telephone 10 to the secure call service server 20 includes the caller's identification information and the called party's identification information, and in this embodiment, the called party's identification information may be the called party's user ID.

In this embodiment, the secure call service server 20 asks the called party's telephone 40 whether the called party's telephone 40 receives a call from the caller when the caller's telephone 10 makes the request for a call and may obtain the called party's telephone number from the called party's telephone 40 when receiving the reply from the called party's telephone 40 that the called party's telephone 40 receives the call (hereinafter referred to as “call permission reply”).

In comparison between the embodiment in FIG. 5 and the embodiment in FIG. 8, in the embodiment in FIG. 5, the called party's telephone number, as the called party's identification information, may be included in the request for a call transmitted by the caller's telephone 10 to the secure call service server 20, but in the embodiment in FIG. 8, the secure call process server 20 may obtain the called party's telephone number only when receiving the call permission reply from the called party. Following operations are the same as those in FIG. 5 (see. descriptions of FIG. 5).

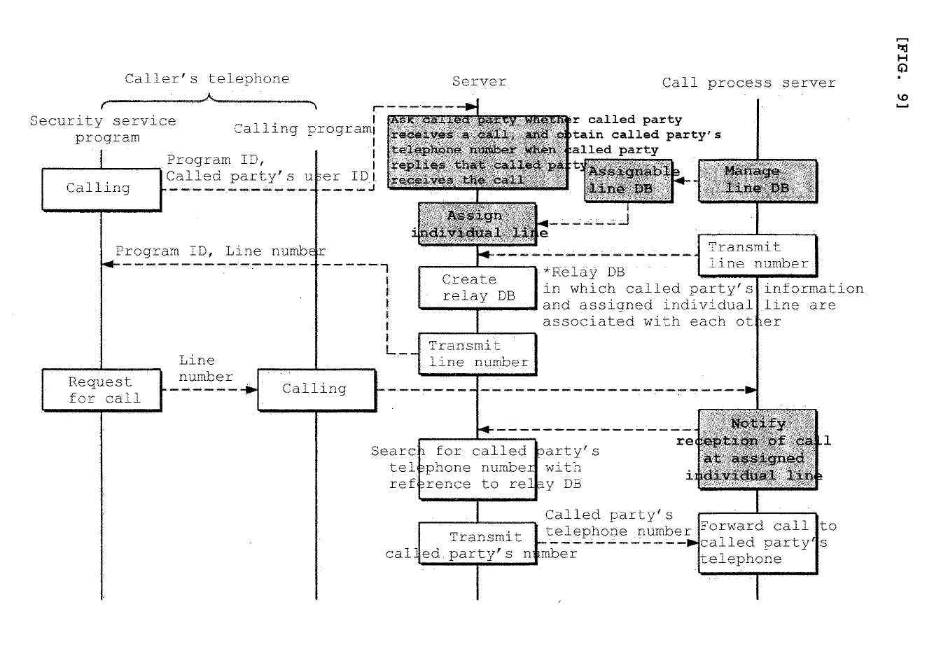

FIG. 9 is a view illustrating a secure call system according to an embodiment of the present invention, and the secure call system in FIG. 1 may be embodied to operate as the secure call system in FIG. 9.

In comparison between the embodiment in FIG. 9 and the embodiment in FIG. 8, in the embodiment in FIG. 9, when receiving a call made by the caller's telephone 10 at the line number assigned to the caller's telephone 10, the call process server 30 notifies the secure call service server 20 that there is a call from the caller's telephone 10 at the assigned line number (hereinafter referred to as “call reception notification”).

In this embodiment, when notified from the call process server 30 that there is a call from the caller's telephone 10 at the assigned line number, the secure call service server 20 transmits to the call process server 30 the called party's telephone number associated with the line number assigned to the caller's telephone 10 with reference to the relay DB 50. The call process server 30 forwards the call, made by the caller's telephone 10 at the line number assigned to the caller's telephone 10, to the called party's telephone number transmitted by the secure call service server 20.

In the embodiment in FIG. 8, the call process server 30 may obtain the called party's telephone number only by transmitting the telephone number of the caller's telephone 10 (i.e. caller's telephone number) as the caller's identification information to the secure call service server 20 even when the caller's telephone 10 makes a call at the assigned line number.

Meanwhile, the call process server 30 in the embodiment in FIG. 9 may obtain the called party's telephone number only by notifying the secure call service server 20 of reception of the call, not of the caller's telephone number.

A computer-implemented secure call service method according to an embodiment of the present invention includes a step in which a caller's telephone 10 displays a telephone call screen for calling, which includes a menu for selecting a called party and making a request for a call made to the selected called party; a step in which the caller's telephone 10 transmits a request for a call to a secure call service server 20 when receiving the request for a call to a called party from the caller on the telephone call screen; a step in which the secure call service server 20 or a call process server 30 assigns any one of line numbers available for a call to the caller's telephone 10; a step in which the secure call service server 20 transmits the assigned line number to the caller's telephone 10; a step in which the caller's telephone 10 makes a call at the assigned line number; a step in which the call process server 30 receives the called party's telephone number from the secure call service server 20; and a step in which the call process server 30 forwards the call, made by the caller's telephone 10 at the assigned line number, to the called party's telephone number, wherein the request for a call transmitted by the caller's telephone 10 to the secure call service server 20 includes the caller's identification information and the called party's identification information, the caller's identification information may include at least one of the caller's user ID, program ID and telephone number, and the called party's identification information may include at least one of the called party's user ID and telephone number.

The above-described computer-implemented secure call service method may further include a step in which the secure call service server 20 creates and stores a relay DB 50 including the time of making a request for a call when the caller's telephone 10 makes the request for a call. The relay DB 50 may further include at least any one of a called party's telephone number, a caller's telephone number and an assigned line number.

In terms of the above-described computer-implemented secure call service method, only when receiving the call from the caller's telephone 10 at the assigned line number within a preset time from the “time of making the request for a call”, the call process server 30 may perform the step of forwarding the call to the called party's telephone number.

In terms of the above-described computer-implemented secure call service method, the program ID may mean an ID of the program which is installed on the caller's telephone 10 and lets the caller's telephone 10 perform steps performed by the caller's telephone 10 out of the above-described steps.

In terms of the above-described computer-implemented secure call service method, the step in which the call process server 30 receives the called party's telephone number from the server 20 may be carried out after the step in which the caller's telephone 10 makes a call at the assigned line number.

In terms of the above-described computer-implemented secure call service method, the step in which the call process server 30 receives the called party's telephone number from the server 20 may be carried out after the step in which the caller's telephone transmits the request for a call to the secure call service server 20 and may be carried out before the step in which the call process server 20 receives the call that is made by the caller's telephone 10 at the assigned line number.

1. A computer-implemented secure call service method in a secure call system comprising a caller's telephone, a called party's telephone, a secure call service server and a call process server comprising:
a step in which the caller's telephone displays a telephone call screen for calling, which comprises a menu for selecting a called party and making a request for a call to the selected called party;
a step in which the caller's telephone transmits a request for a call to the secure call service server when receiving the request for a call to a called party from the caller on the telephone call screen;
a step in which the secure call service server or the call process server assigns any one of line numbers available for a call to the caller's telephone;
a step in which the secure call service server transmits the assigned line number to the caller's telephone;
a step in which the caller's telephone makes a call at the assigned line number;
a step in which the call process server receives the called party's telephone number from the secure call service server; and
a step in which the call process server forwards the call, made by the caller's telephone at the assigned line number, to the called party's telephone number,
wherein the request for a call transmitted by the caller's telephone to the secure call service server comprises the caller's identification information and the called party's identification information,
the caller's identification information comprises at least one of the caller's user ID, program ID and telephone number, and
the called party's identification information comprises at least one of the called party's user ID and telephone number.

2. The computer-implemented secure call service method according to claim 1, further comprising:
a step in which the secure call service server creates and stores a relay DB including the time of making the request for a call when the caller's telephone makes the request for a call,
wherein the relay DB further comprises at least any one of the called party's telephone number, the caller's telephone number and the assigned line number.

3. The computer-implemented secure call service method according to claim 2,
wherein the call process server forwards the call to the called party's telephone number only when receiving the call, made by the caller's telephone at the assigned line number, within a preset time from the time of making the request for a call.

4. The computer-implemented secure call service method according to claim 3,
wherein the program ID is configured to be the ID of a program which is installed on the caller's telephone and lets the caller's telephone perform steps performed by the caller's telephone out of the steps.

5. The computer-implemented secure call service method according to claim 1,
wherein the step in which the call process server receives the called party's telephone number from the server is carried out after the step in which the caller's telephone makes a call at the assigned line number.

6. The computer-implemented secure call service method, according to claim 1,
wherein the step in which the call process server receives the called party's telephone number from the server is carried out after the step in which the caller's telephone transmits a request for a call to the secure call service server and is carried out before the step in which the call process server receives the call made by the caller's telephone 10 at the assigned line number.

7. A secure call system comprising a caller's telephone, a called party's telephone, a secure call service server and a call process server,
wherein the caller's telephone displays a telephone call screen for calling, which comprises a menu for selecting a called party and making a request for a call to the selected called party, and transmits a request for a call to the secure call service server when receiving the request for a call to a called party from the caller on the telephone call screen,
the call process server assigns any one of line numbers available for a call to the caller's telephone, or the secure call service server requests the call process server to assign a line number and receives the assigned line number from the call process server to transmit the assigned line number to the caller's telephone when the secure call service server receives the request for a call from the caller's telephone,
the caller's telephone makes a call at the line number transmitted by the secure call service server,
the call process server receives the called party's telephone number from the secure call service server,
the call process server forwards the call, made by the caller's telephone at the assigned line number, to the called party's telephone when receiving the call made by the caller's telephone at the assigned line number,
the request for a call transmitted by the caller's telephone to the secure call service server comprises the caller's identification information and the called party's identification information,
the caller's identification information comprises at least one of the caller's user ID, program ID and telephone number, and
the called party's identification information comprises at least one of the called party's user ID and telephone number.

8. The secure call system according to claim 7,
wherein the secure call service server creates and stores a relay DB including the time of making the request for a call when the caller's telephone makes the request for a call, and
the relay DB further comprises at least any one of the called party's telephone number, the caller's telephone number and the assigned line number.

9. The secure call system according to claim 8,
Wherein the relay DB associates the called party's telephone number with the caller's telephone number and stores the called party's telephone number and the caller's telephone number.

10. The secure call system according to claim 9,
wherein when the call process server receives the call made by the caller's telephone at the assigned line number, the call process server transmits the caller's telephone number to the secure call service server, and
the secure call service server transmits to the call process server the called party's telephone number associated with the caller's telephone number transmitted by the call process server with reference to the relay DB, and the call process server forwards the call, made by the caller's telephone at the assigned line number, to the called party's telephone number transmitted by the secure call service server.

11. The secure call system according to claim 10,
wherein the secure call service server transmits the called party's telephone number to the call process server only when receiving the caller's telephone number from the call process server within a preset time from the time associated with the caller's telephone number stored in the relay DB.

12. The secure call system according to claim 8,
wherein the relay DB associates the called party's telephone number with the line number assigned to the caller's telephone and stores the called party's telephone number and the line number assigned to the caller's telephone,
when the call process server receives a call made by the caller's telephone at the assigned line number, the call process server notifies the secure call service server that there is a call from the caller's telephone at the assigned line number,
when the secure call service server is notified from the call process server that there is a call from the caller's telephone at the assigned line number, the secure call service server transmits to the call process server the called party's telephone number associated with the line number assigned to the caller's telephone with reference to the relay DB, and
the call process server forwards the call, made by the caller's telephone at the assigned line number, to the called party's telephone number transmitted by the secure call service server.

13. The secure call system according to claim 12,
wherein the secure call service server transmits the called party's telephone number to the call service server only when the secure call service server receives the notification from the call process server within a preset time from the time associated with the line number stored in the relay DB or when the call process server receives the call from the caller's telephone within a preset time from the time associated with the line number stored in the relay DB.

14. The secure call system according to claim 7,
wherein the called party's identification information is configured to be the called party's user ID, and
the secure call service server asks the called party's telephone whether the called party's telephone receives the call from the caller when the caller's telephone makes the request for a call and obtains the called party's telephone number from the called party's telephone when receiving the reply from the called party's telephone that the called party's telephone receives the call.

15. The secure call system according to claim 14,
wherein the secure call service server creates and stores a relay DB including the time of making the request for the call when the caller's telephone makes the request for a call, and
the relay DB further comprises at least any one of the called party's telephone number, the caller's telephone number and the assigned line number.

16. The secure call system according to claim 15,
Wherein the relay DB associates the called party's telephone number obtained from the called party's telephone with the caller's telephone number and stores the called party's telephone number obtained from the called party's telephone and the caller's telephone number.

17. The secure call system according to claim 16,
wherein when the call process server receives the call made by the caller's telephone at the assigned line number, the call process server transmits the caller's telephone number to the secure call service server, and
the secure call service server transmits to the call process server the called party's telephone number associated with the caller's telephone number transmitted by the call process server with reference to the relay DB, and the call process server forwards the call, made by the caller's telephone at the assigned line number, to the called party's telephone number transmitted by the secure call service server.

18. The secure call system according to claim 17,
wherein the secure call service server transmits the called party's telephone number to the call process server only when receiving the caller's telephone number from the call process server within a preset time from the time associated with the caller's telephone number stored in the relay DB.

19. The secure call system according to claim 15,
wherein the relay DB associates the called party's telephone number with the line number assigned to the caller's telephone and stores the called party's telephone number and the line number assigned to the caller's telephone,
when the call process server receives the call made by the caller's telephone at the assigned line number, the call process server notifies the secure call service server that there is a call from the caller's telephone at the assigned line number,
when the secure call service server is notified from the call process server that there is a call from the caller's telephone at the assigned line number, the secure call service server transmits to the call process server the called party's telephone number associated with the line number assigned to the caller's telephone with reference to the relay DB, and
the call process server forwards the call, made by the caller's telephone at the assigned line number, to the called party's telephone number transmitted by the secure call service server.

20. The secure call system according to claim 19,
wherein the secure call service server transmits the called party's telephone number to the call service server only when the secure call service server receives the notification from the call process server within a preset time from the time associated with the line number stored in the relay DB or when the call process server receives the call from the caller's telephone within a preset time from the time associated with the line number stored in the relay DB.
